(19) United States
(12) Patent Application Publication
(10) Pub. No.: US 2016/0318743 A1
(43) Pub. Date: Nov. 3, 2016

(54) Crow Bar or Pry Bar with Lever Arm and Method Therefore

(71) Applicant: Edward M. Richards, Davie, FL (US)

(72) Inventor: Edward M. Richards, Davie, FL (US)

(21) Appl. No.: 15/138,871

(22) Filed: Apr. 26, 2016

Related U.S. Application Data
(60) Provisional application No. 62/154,770, filed on Apr. 30, 2015.

(51) Int. Cl. B66F 15/00

(52) U.S. Cl. CPC B66F 15/00

(57) ABSTRACT

Long-handled lever rotates lower cam surface about an upper pivot axle between 2 spaced-apart fixed wedge-bodies which are further held apart by a lower pivot axle. A movable wedge-body between the fixed bodies rotates on the lower axle due to a cam follower actuated by the lever cam surface. At rest without cam action, the 3 acute-angle-shaped wedge feet form a composite wedge forced into the pry space between beams, etc. With lever rotations, the movable wedge foot moves away from the fixed wedge feet by rotation about the lower pivot axle. The method mounts fixed wedges on first and second pivots. Counterclockwise movement leverages the lever about the first pivot, rotating a convex cam over a concave cam follower on an upper ankle of the movable wedge causing clockwise rotation of the movable wedge about the second pivot resulting in separation of fixed versus movable acute wedge surfaces.

This is a regular patent application based upon and claiming the benefit of provisional patent application Ser. No. 62/154,770 filed Apr. 30, 2015, the contents of which is incorporated herein by reference thereto.

The present invention relates to a crowbar or a pride bar and a pry method.

There is a need to provide a pry bar or a crowbar that can be inserted between two adjacent beams or slabs or in a space sought to be pried open. Current pry bars are simple wedges which are integral as a single piece with a slightly curved handle lever.

There is a need for an improved pry bar or crowbar system which can amplify the force on the pry bar handle and deliver this amplified force between the beams, slabs or pry space to open the space.

### OBJECTS OF THE INVENTION

It is an object of the present invention to provide a crowbar or a pry bar delivering greater force to the beams, slabs or space sought to be pried apart.

It is another object of the present invention to maintain the slab or beam at an elevated position relative to the fixed or second slab or floor with the use of nominal effort.

It is a further object of the present invention to provide a system with fixed wedge feet disposed at outboard positions with respect to an inboard movable foot disposed at an inboard position between the two fixed wedges. A lever arm rotatably acts on the inboard movable wedge and the foot of the movable wedge opens a pry space between the movable foot and the feet of the fixed wedges.

### SUMMARY OF THE INVENTION

The pry bar system includes an elongated lever handle having a forward facing cam surface adjacent a lower terminal end. A pair of fixed wedge-shaped bodies have forward facing wedge-shaped feet. These fixed bodies are held apart by an upper axle pin and a lower axle pin. The elongated lever handle is rotatably mounted between the pair of fixed wedge-shaped bodies on the upper axle pin. A movable wedge-shaped body is disposed between the fixed wedge-shaped bodies and is rotatably mounted on the lower axle pin between the fixed wedge-shaped bodies. The movable wedge-shaped body has an upper ankle segment with a rearward facing cam follower surface actuated by the rotation of the cam surface of the lever handle. In this manner, the foot of the movable wedge-shaped body separates apart from the feet of the fixed wedge-shaped bodies by rotation about the lower axle pin of the movable wedge-shaped body. The wedge-shaped bodies all have forward facing feet which have substantially the same cross sectional shape creating a composite wedge when the lever handle has not engaged its cam surface on said cam follower surface. A spring may be included to assist in the return of the movable wedge-shaped body to the aligned position with respect to the fixed wedge-shaped bodies.

The method of opening the pry space includes the steps of mounting two spaced apart wedges on a first pivot pin and a second pivot pin. Counterclockwise movement leverages the elongated lever arm about the first pivot by rotating a substantially vertical convex cam over a substantially vertical concave cam follower surface formed on an upper region of the movable wedge. The method rotates the movable wedge about the second pivot between the two fixed wedges when counterclockwise movement translates into clockwise movement of the cam follower. The result is the separation of fixed acute wedge surfaces from movable acute wedge surfaces with the clockwise movement of the movable wedge, thereby opening the pry space with the fixed and movable acute wedge surfaces.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the lever arm and the configuration of the movable, inboard wedge (the outboard wedges not shown).

FIG. 2 diagrammatically illustrates a bottom view of the pry or lever bar system showing the inboard movable foot in the fixed outboard feet.

FIG. 3 diagrammatically illustrates the wedges in alignment and the lever arm perpendicular to the lower surfaces of the wedge feet.

FIGS. 4-6 diagrammatically illustrate the operation of the crowbar or pry bar increasing the pry space between the movable foot and the fixed wedge feet.

### DESCRIPTION OF THE EMBODIMENTS OF THE PRESENT INVENTION

The present invention relates to a crowbar or a pride bar.

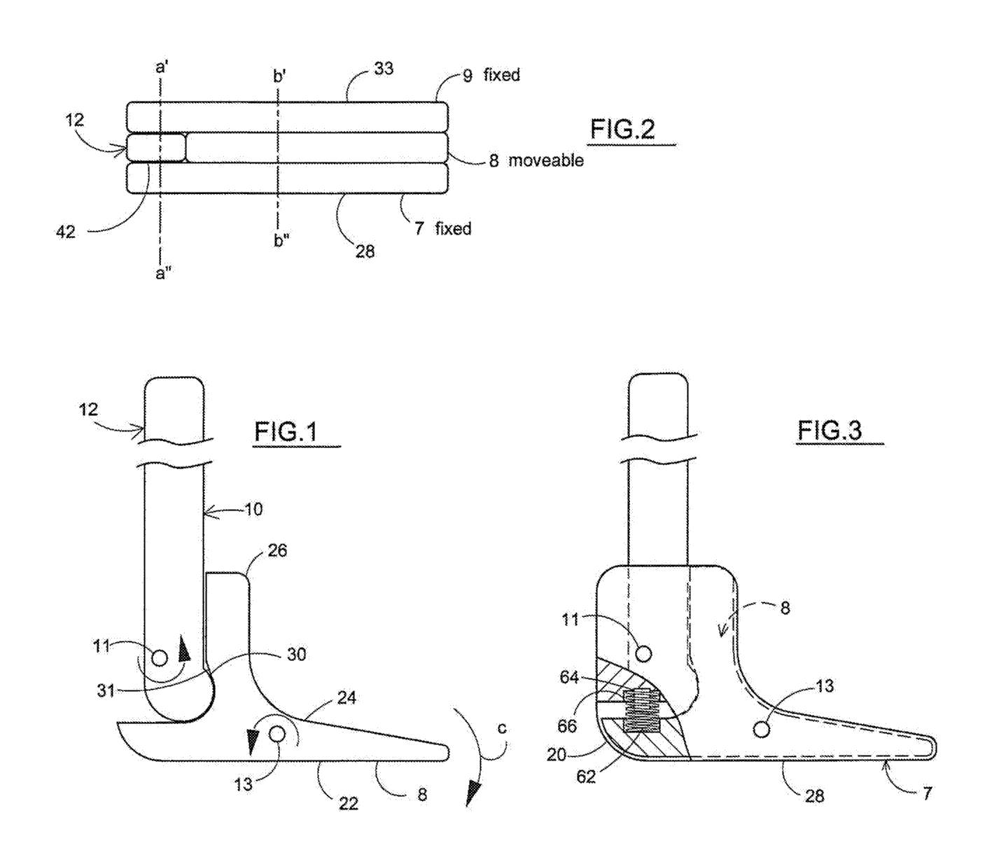

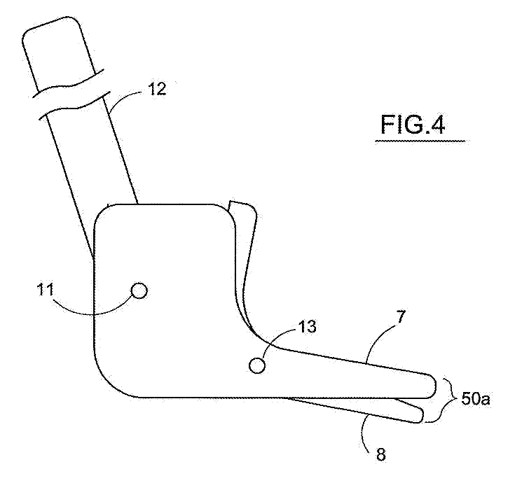

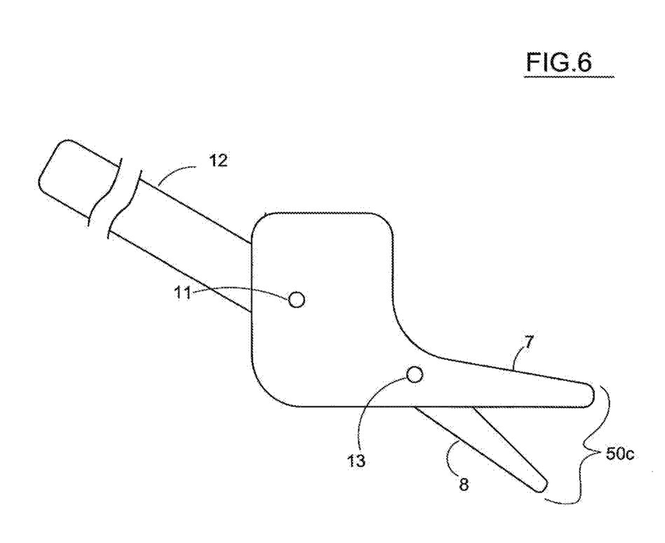

The crow bar or pry bar 10 with lever arm 12 is shown in FIGS. 1-7, wherein FIGS. 4-7 show the levered bar in action, causing an ever expanding larger wedge opening 50a, 50b, 50c between the left and right fixed wedges 7, 9 (FIG. 2) and the inboard movable wedge 8.

FIGS. 1-3 show that the lever arm handle 12 is pivotally movable about axis 11 (see axis a′-a″ in FIG. 2), which runs through the body 20 of the levered pry bar 10. In FIG. 2, a cam surface 30 (on the lower end of the lever arm handle) acts on cam follower surface 31 formed on one side of the inboard wedge element 8. This inboard wedge 8 pivotally moves about axis 13 (see axis b′-b″ in FIG. 2) formed and held by the body 20.

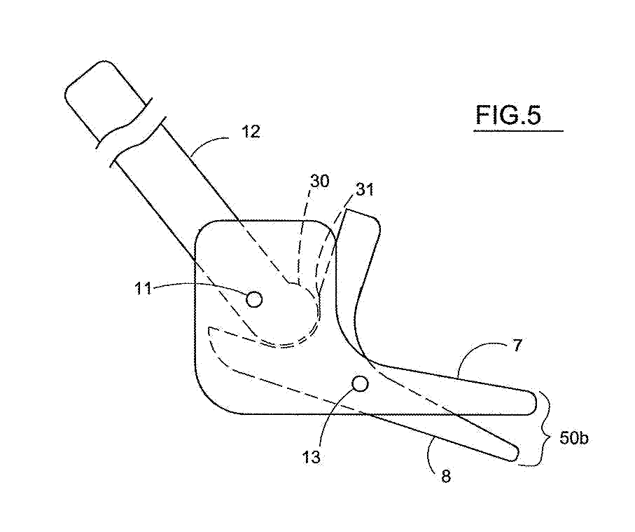

FIG. 3 shows left and right fixed wedges 7, 9. These fixed wedges, or portions thereof, form the fixed body elements (the left and right body elements) for body 20. FIG. 3 shows the inboard wedge 8 in dashed lines, to the inboard side of the left fixed wedge 7.

Each wedge 7, 8, 9 has a foot wedge segment, a body segment and an upper ankle segment. With respect to movable wedge 8, foot segment 22, body segment 24 and upper ankle segment 26 are shown. Each foot segment 22, 28, 33 for wedges 8, 7, 9, respectively, are substantially the same size and shape, thereby forming a simple composite wedge which can be inserted between the slabs, beams or other structures to be pried open. The composite wedge is shown in FIG. 3. The top surfaces of the foot segments 22, 28, 33 are aligned in FIGS. 1 and 3. The same shape and alignment is provided for with respect to the bottom surfaces of foot segments 22, 28, 33.

The forward facing surfaces of the ankle segments of each wedge (see ankle segment 26 of movable wedge 8 in FIG. 1) also have a similar shape although this portion of the wedges are similarly shaped for aesthetic purposes rather than functional purposes.

FIG. 3 shows the pry bar at rest, when all the wedges 7, 8, 9 are aligned to form a small acute angle composite wedge. The small acute angle composite wedge, sometimes referred to as the composite wedge, is forced between the adjacent beams or slabs or is forced into a pry-open slot space.

A spring 62 may be included to assist in the return of the movable wedge-shaped body 8 to the aligned position with respect to the fixed wedge-shaped bodies 7, 9. In one embodiment, a compression spring in an internal channel in wedge 7 or 9 is used with a fixed pin, blockage or blind channel wall 66 in wedge 7 or 9 with the other end of the spring in movable wedge 8 held in place with a fixed pin, blockage or blind channel wall 64. Of course, a tension spring can be used dependent upon the interrelated location of spring retainer 66 in the wedge 7 or 9 and the spring retainer 64 in the movable wedge 8. Multiple springs may be used, one for each wedge 7 or 9.

FIGS. 4-6 show the lever handle 12 at various angled positions swung away from the fixed body 20. In FIG. 1, the lever arm handle is substantially perpendicular (normal) to the lower foot surfaces 22, 28, 33 of the wedges.

In FIGS. 4-6, the upper region of the inboard wedge 8, namely the rear surface of the ankle segment 26 of wedge 8, is rotated away from the ankle segments of the fixed wedges 7, 9 by the protruding cam surface 30 of lever arm 12 acting on the cam follower surface 31 of the ankle segment 26 of movable wedge 8. The arm 12 rotates counterclockwise about axis a′-a″ (axle pivot pin 11) and the movable wedge 8 moves clockwise about axis b′-b″ (axle pivot pin 13) which moves inboard wedge 8 downward in direction c, away from the plane formed by the lower surfaces of feet 28, 33. Feet 28, 33 are fixed relative to the axle pins 11, 13.

As shown in FIG. 2, the inboard vertical ankle surfaces 42, 44 form a vertical slot within which the lower terminal end of the lever arm 12 resides when the arm 12 is normal to the lower surfaces of feet 22, 28, 33 (see FIG. 1 for this normal position). The fixed wedges 7, 9 are fixed together by pins 11, 13 and the lever arm 12 moves with respect to fixed wedges about the axle pin 11.

The pry action is caused by the spatial differential 50a, 50b, 50c (FIGS. 4-6) between the foot 22 of inboard wedge 8 and the feet 28, 33 of left and right fixed wedges 7, 9.

The wedge pry bar system can be expanded by adding a number of movable wedges and some combination of fixed wedges. Stated otherwise, there could be three movable wedges and two fixed wedges. In this configuration, the lower region of the lever handle 12 would be fork-shaped to act on the rear surfaces of the ankles of the movable wedges. Other configurations and combinations of fixed and movable wedges may be employed on in more complex pry bar system. To show this multi-wedged pry bar, the bottom view of the fixed-movable-fixed wedge system can be expanded to a fixed-movable-fixed-movable 4-wedge mechanical system. In the 4-wedge system, the lower region of the lever arm would have two tines, each carrying a cam surface. A further expansion could be a movable-fixed-movable-fixed-movable 5-wedge system with a lever arm forming a three tine forks, each carrying a cam surface. A 7-wedge system is a fixed-movable-fixed-movable-fixed-movable-fixed system with a 3 tine forked lever arm.

The method of opening the pry space (see space 50a, 50b, 50c) includes the steps of mounting two spaced apart wedges 7, 9 on a first pivot pin 11 and a second pivot pin 13. Counterclockwise movement shown in FIGS. 4-6 leverages the elongated lever arm about the first pivot 11 by rotating a substantially vertical convex cam 30 over a substantially vertical concave cam follower surface 31 formed on an upper region of the movable wedge 8. The method rotates the movable wedge 8 about the second pivot 13 between the two fixed wedges 7, 9 when counterclockwise movement translates into clockwise movement c of the cam follower 31. The result is the separation of fixed acute wedge surfaces 28, 33 from movable acute wedge surfaces 22 with the clockwise movement c of the movable wedge 7, thereby opening the pry space 50a, 50b, 50c with the fixed and movable acute wedge surfaces 28, 22, 33.

The claims appended hereto are meant to cover modifications and changes within the scope and spirit of the present invention.

What is claim is:

1. A pry bar system comprising:
an elongated lever handle having a forward facing cam surface adjacent a lower terminal end;
a pair of fixed wedge-shaped bodies having forward facing wedge-shaped feet, said fixed bodies held apart by an upper axle pin and a lower axle pin;
said elongated lever handle rotatably mounted between the pair of fixed wedge-shaped bodies on said upper axle pin;
a movable wedge-shaped body disposed between said fixed wedge-shaped bodies and rotatably mounted on said lower axle pin between said fixed wedge-shaped bodies, said movable wedge-shaped body having an upper ankle segment with a rearward facing cam follower surface actuated by the rotation of said cam surface of said lever handle;
whereby the movable wedge-shaped body separates apart from the fixed wedge-shaped bodies by rotation about said lower axle pin.

2. A pry bar system as claimed in claim 1 wherein all the wedge-shaped bodies have forward facing feet which have substantially the same cross sectional shape creating a composite wedge when the lever handle has not engaged its cam surface on said cam follower surface.

3. A pry bar system as claimed in claim 1 wherein a plurality of movable wedge-shaped bodies are rotatably mounted with respect to the pair of fixed wedge-shaped bodies on said lower axle pin and wherein one of the movable wedge-shaped bodies is disposed between the pair of fixed bodies.

4. A pry bar system as claimed in claim 1 including
a plurality of movable wedge-shaped bodies rotatably mounted on said lower axle pin;
a plurality of fixed wedge-shaped bodies;
wherein one of the movable wedge-shaped bodies is disposed between one pair of the plurality of fixed bodies.

5. A method of opening a pry space comprising:
mounting two spaced apart wedges on a first pivot pin and a second pivot pin;
leveraging counterclockwise movement of an elongated lever arm about the first pivot by rotating a substantially vertical convex cam over a substantially vertical concave cam follower surface formed on an upper region of a movable wedge;
rotating the movable wedge about the second pivot between the two fixed wedges when counterclockwise movement translates into clockwise movement of the cam follower; and
separating fixed acute wedge surfaces from movable acute wedge surfaces with the clockwise movement of the movable wedge, thereby opening the pry space with the fixed and movable acute wedge surfaces.
